(19) United States
(12) Patent Application Publication
(10) Pub. No.: US 2013/0139062 A1
(43) Pub. Date: May 30, 2013

(54) Audio Indicator of Position Within a User Interface

(71) Applicant: Chang J. Rhee, San Diego, CA (US)

(72) Inventor: Chang J. Rhee, San Diego, CA (US)

(73) Assignee: QUALCOMM INNOVATION CENTER, INC., San Diego, CA (US)

(21) Appl. No.: 13/465,765

(22) Filed: May 7, 2012

Related U.S. Application Data
(60) Provisional application No. 61/564,295, filed on Nov. 28, 2011.

(51) Int. Cl. G06F 3/048

(52) U.S. Cl. 715/727

(57) ABSTRACT

A mobile communication device and method for controlling a user interface of the mobile communication device are disclosed. The method includes generating a multi-page graphical user interface that enables a user of the mobile communication device to control operations of the mobile communication device, displaying a current page of the multi-page user interface, changing the current page of the multi-page user interface that is displayed in response to a user action, and projecting an audible sound for each page of the multi-page user interface that is displayed.

### FIELD

The present invention relates to communication devices. In particular, but not by way of limitation, the present invention relates to control of operations within a communication device.

### BACKGROUND

Touchscreen-enabled communication devices, such as smartphones and tablet computers, are capable of running applications (e.g., educational, gaming, financial, and utility applications), also referred to as “apps,” that are useful in a variety of contexts. These apps have become so popular that it is not uncommon for some people to have over one hundred apps that reside on their communication devices. To access these apps, an icon that represents each app usually resides in the main user interface of a communication device. However, due to the limited space available on a typical display of a communication device, the user interface may be divided into several pages with only a single page displayed to the user at a given time. As a consequence, a user may have to scroll through several pages of a user interface before finding an icon for an app that the user wants to run.

Although graphical displays have been used to help users to identify the particular page of the user interface that they are viewing, when the users are unable to pay close attention to what is displayed on the screen of the mobile device, it is difficult for the users to “sense” where they are within the user interface, and as a consequence, it is difficult for users to find an app or control icon unless they are closely looking at the user interface.

### SUMMARY

An exemplary aspect of the invention may be characterized as a mobile communication device that includes a display that presents a current page of a multi-page user interface, and the mobile communication device includes a user interface navigation component that generates the multi-page user interface and changes the current page of the multi-page user interface in response to actions of the user. In addition, the mobile communication device includes an audio user interface location indicator that generates different audio signals based upon the current page of the multi-page user interface that is being displayed, and an audio transducer generates audible sounds based upon the audio signal.

Another aspect may be characterized as a method for controlling a mobile communication device that includes generating a multi-page graphical user interface that enables a user of the mobile communication device to control operations of the mobile communication device, displaying a current page of the multi-page user interface, changing the current page that is displayed in response to a user action, and projecting an audible sound for each page that is being displayed.

### BRIEF DESCRIPTION OF THE DRAWINGS

FIG. 1 is a block diagram depicting components of an exemplary embodiment of a mobile communication device;

FIG. 2 is a block diagram depicting components of an exemplary embodiment of the UI-location indicator depicted in FIG. 1;

FIG. 3 is a block diagram depicting exemplary physical components of the embodiments depicted in FIGS. 1 and 2; and

FIG. 4 is a flowchart depicting an exemplary method that may be traversed in connection with the embodiments depicted in FIGS. 1-3.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspects may be practiced without these specific details.

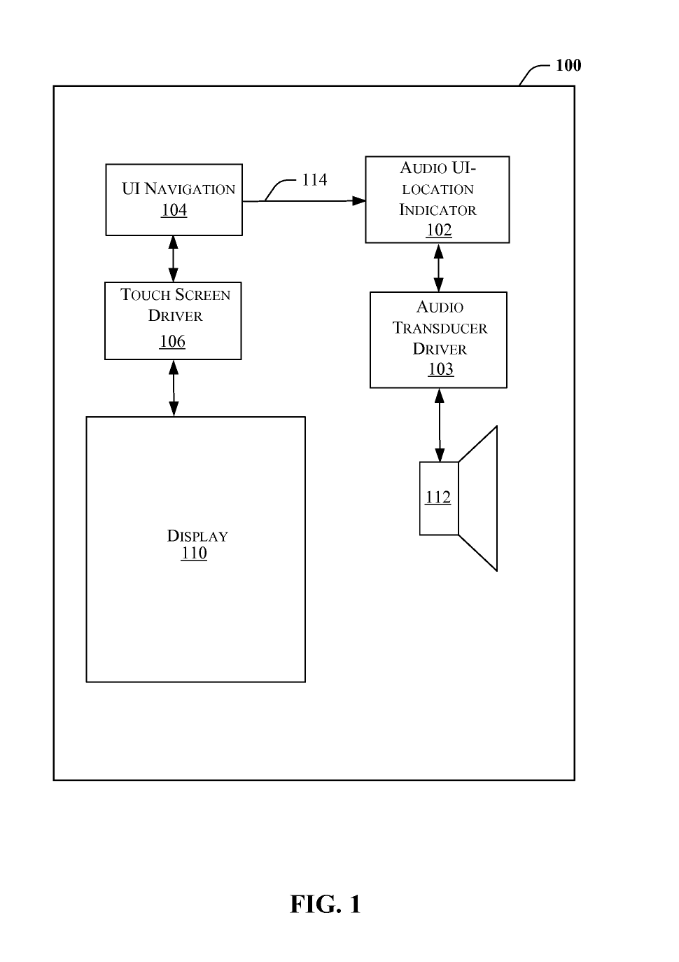

Referring first to FIG. 1, shown is a block diagram of a mobile communication device 100. As shown, the mobile communication device 100 includes a UI navigation component 104 in communication with an audio UI-location indicator 102 and a display 110 via a touch screen driver 106. And the audio UI-location indicator 102 is coupled to an audio transducer 112 via an audio transducer driver 103. The illustrated arrangement of the components depicted in FIG. 1 is logical, the connections between the various components are exemplary only, and the depiction of this embodiment is not meant to be an actual hardware diagram; thus the components can be combined or further separated in an actual implementation, and the components can be connected in a variety of ways without changing the basic operation of the system. And as one of ordinary skill in the art will appreciate in view of this disclosure, the depicted components may be realized by software, hardware, firmware and combinations thereof.

The mobile communication device 100 may be realized by a wireless communication device such as a smartphone, PDA, netbook, tablet, laptop computer and other wireless devices. But the mobile communication device 100 may work in tandem with wireline and wireless communication devices. In many implementations, the mobile communication device 100 includes components (not shown) associated with cellular communication to enable a user of the mobile communication device 100 to communicate by voice communication with others and to access remote networks, including the Internet, known cellular networks (e.g., CDMA, GPRS, LTE, and UMTS networks), and yet to be developed communication networks.

In general, the UI navigation component 104 generates a multi-page user interface that enables control and interaction with various functions of the mobile communication device 100, and enables a user to navigate through the different pages of the user interface of the mobile communication device 100. And the audio UI-location indicator 102 provides an audio indication of the user's location within the user interface. For example, the audio UI-location indicator 102 may provide a sound with a frequency that varies based upon the location of the user in the user interface. As a consequence, the user need not closely scrutinize what is displayed on the mobile communication device 100 to determine where the user is within the user interface.

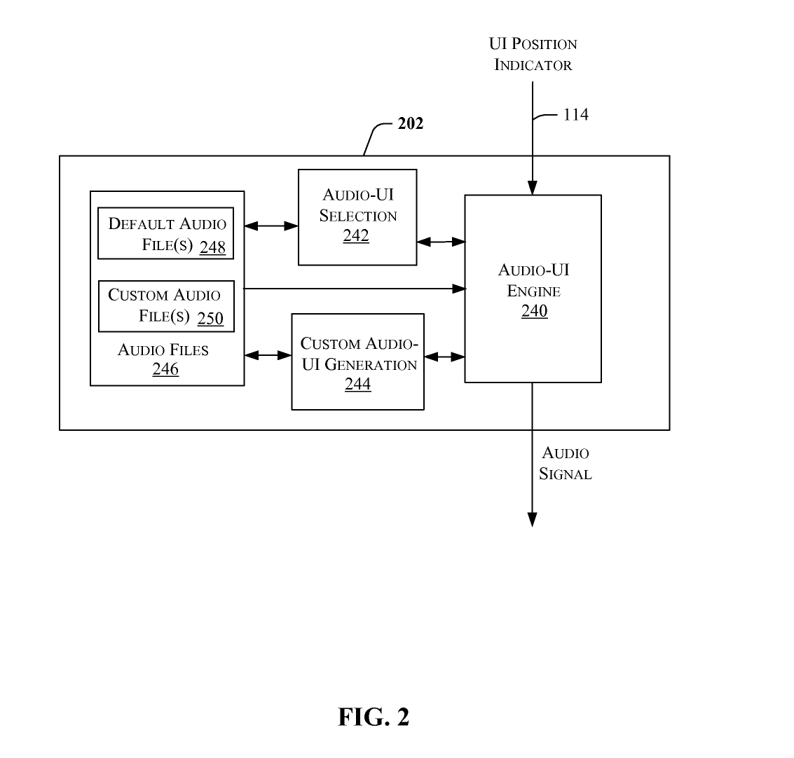

As discussed further herein with reference to FIG. 2, in some implementations, the audio UI-location indicator 102 is configured to enable a user to select default sounds for each page of the user interface or the user may customize the sounds that are associated with each page of the user interface.

As one of ordinary skill in the art will appreciate, the touch screen driver 106 interacts with the display 110 using commands and/or signals that are specific to the type of display that is used to realize the display 110. As one of ordinary skill in the art will appreciate, there are many different types of displays (e.g., LCD and OLED displays) and different manufacturers for most every type of display. So in general, the touch screen driver 106 is designed to communicate with the specific display that is used to realize the display 110 and to interact with the UI navigation component 104 using generic function calls.

Similarly, the audio transducer driver 103, as one of ordinary skill in the art will appreciate, is specifically designed to provide specific signals to drive the particular type of audio transducer that is used to realize the audio transducer 112 (also referred to herein as a speaker). More specifically, there are a variety of types of audio transducers and there may be multiple vendors that make each type of audio transducer. As a consequence, the audio transducer driver 103 translates generic audible sound commands to the specific signals that achieve the desired sounds out of the audio transducer 112.

In operation, the UI navigation component 104 generates a user interface that includes many pages, and each page is sized to occupy the display 110 so that icons and other portions of the user interface, including text, are large enough to be discernible and/or legible. As those of ordinary skill in the art will appreciate, the user interface that is generated by the UI navigation component 104 may include several pages to accommodate the numerous icons that are used to select control functions and apps that may be stored on the mobile communication device 100. It is contemplated, for example, that a user may have over one hundred apps stored on the mobile communication device 100 that are each selectable by touching a corresponding one of over a hundred icons that are distributed over more than ten pages of the user interface. The user interface may be any graphical user interface that includes multiple pages such as the graphical user interfaces that are utilized in ADROID, WINDOWS, or APPLE based mobile devices.

As a consequence, the user may have to scroll through several pages (e.g., by swiping their finger across the display 110) to locate a particular icon to launch a particular app. When a user touches (e.g., swipes) the display 110 to select the particular page, one or more physical characteristics (e.g., voltage, impedance, etc.) of the display 110 change, and the touch screen driver 106 translates the physical changes that occur into generic indications of the user's touch-events, which the UI navigation component 104 utilizes as commands to change a particular page of the user interface that is displayed on the display 110.

In this embodiment, when the UI navigation component 104 changes the view of the user interface to a new page, a UI-position indicator 114 is provided to the audio UI location indicator 102, which then prompts, via the audio-transducer driver 103, the audio transducer 112 to produce an audible sound that the user can associate with the particular user-interface page that is being displayed. In this way, the user is able to determine which page of the user interface is being displayed without having to visually see the display 110. In many embodiments, the audio UI location indicator 102 prompts a different sound to be produced for each different page of the user interface. Each audio sound may vary in pitch so that each page of a user interface may be distinguished from other pages of the user interface, but each audible sound may differ from other sounds in a different ways. In some implementations, the audible sound is produced only briefly when the page is first displayed so that the sounds do not become annoying.

As discussed above, the components depicted in FIG. 1 are not intended to necessarily correspond to discrete physical elements, and the depicted components can be combined or further separated in an actual implementation. In other words, the specific depiction in FIG. 1 is to facilitate a clear description of functional components of the exemplary embodiment, but one of ordinary skill in the art will appreciate that each of these components depicted in FIG. 1 may have several constituent components, and each of the depicted components in FIG. 1 may share constituent constructs with other the components depicted in FIG. 1.

Referring to FIG. 2, shown is a block diagram depicting components of an exemplary embodiment of the audio UI-location indicator 102 in FIG. 1. As shown, the audio UI-location indicator 202 in this embodiment includes an audio-UI engine 240 that is disposed to receive the UI-position indicator 114 from the UI navigation component 104 described with reference to FIG. 1, and in response, generate an audio signal. The audio-UI engine 240 is also coupled to an audio-UI selection component 242 and a custom audio-UI generation component 244, and each of the audio-UI selection component 242 and the custom audio-UI generation component 244 is coupled to an audio file library 246. And the audio file library 246 includes default audio files 248 and custom audio files 250. The components depicted in FIG. 2 are logical components that can be combined or further separated in an actual implementation, and the components can be connected in a variety of ways without changing the basic operation of the system. And as one of ordinary skill in the art will appreciate in view of this disclosure, the depicted components may be realized by software, hardware, firmware and combinations thereof.

In general, the audio-UI engine 240 manages operations of the audio UI-location indicator 202 and generates audio signals (e.g., digital representations of audio signals) in response to the UI position indicator 114 from the UI navigation component 104. For example, the audio-UI engine 240 may provide a control interface (e.g., a graphical user interface that is provided via a touch screen implementation of the display 110) that enables a user to initiate functions of the audio-UI selection component 242 and the custom audio-UI generation component 244. When initiated, the audio-UI selection component 242 enables a user to select either default audio files 248 or custom audio files 250 to be associated with the pages of the user interface.

The default audio files 248 may include audio files created in advance of the user receiving the mobile communication device 100. For example, the default audio files 248 may reside along with the operating system and software on the mobile communication device 100 when it is sold. The default audio files 248 may include audio data for each page of the user interface that define a different frequency for each page of the user interface. It is contemplated that collectively the frequencies may be a portion of a song so that as the user of the mobile communication device 100 scrolls through the different pages of the user interface, the song is played. Alternatively, the default audio files 248 may include more descriptive audio content. For example, the default audio files 248 may include data to emulate words such as “home,” “utilities,” “widgets,” “social apps,” or “one,” “two,” and “three” so that the audible words describe which page of the user interface is currently being displayed.

The custom audio-UI generation component 244 generally functions to enable a user to create the custom audio files 250. For example, the custom audio-UI generation component 244 may enable a user to select particular ones of the default audio files 248 to create a new audio compilation that is stored as one of the custom audio files 250. And then the user may select (using the audio-UI selection component 242) the new audio compilation from among the custom audio files 250 to be used by the audio-UI engine 240 to generate different sounds for different pages of the user interface.

As another example, the custom audio-UI generation component 244 may enable a user to select other audio content such as a user's favorite song, and the custom audio-UI generation component 244 may extract a portion of the song and save the extracted portion in the collection of custom audio files 250 so that the portion of the user's favorite song is played as the user scrolls through the pages of the user interface. Alternatively, the user may select a different song for each page of the user interface, and a portion of each song may be briefly played each time a new page in the user interface is accessed.

The custom audio-UI generation component 244 may also have a capture function that enables the user to capture and store sounds with the mobile communication device 100. For example, during a custom audio UI setup routine, the custom audio-UI generation component 244 may prompt the user to scroll through the user interface, page by page, and then prompt the user to speak a word each time a different page is displayed. In this way, the user can associate the captured audio with each page of the user interface, and a digital representation of the captured audio may be stored among the selectable custom audio files 250.

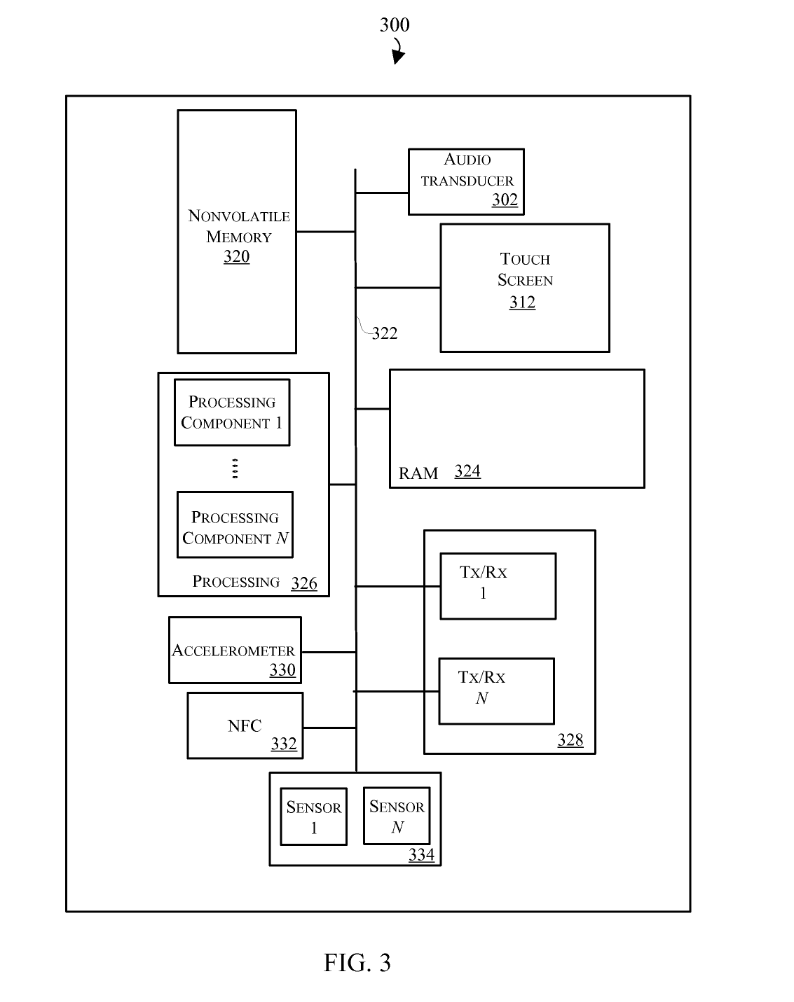

Referring next to FIG. 3, shown is a block diagram depicting physical components of an exemplary mobile communication device 300 that may be utilized to realize the mobile communication device 100 described with reference to FIG. 1 and the components depicted in FIG. 2. Although other architectures and components may be used, FIG. 3 depicts one exemplary approach to implementing a mobile communication device 300. As shown, the communication device 300 in this embodiment includes an audio transducer 302 (e.g., a speaker), a touchscreen 312, and nonvolatile memory 320 that are coupled to a bus 322 that is also coupled to random access memory (“RAM”) 324, N processing components 326, and a transceiver component 328 that includes N transceivers, an accelerometer 330, and a near field communication (NFC) component 332, and a collection of N sensors 334. Although the components depicted in FIG. 3 represent physical components, FIG. 3 is not intended to be a hardware diagram; thus many of the components depicted in FIG. 3 may be realized by common constructs or distributed among additional physical components. Moreover, it is certainly contemplated that other existing and yet-to-be-developed physical components and architectures may be utilized to implement the functional components described with reference to FIG. 3.

The audio transducer 302 generally operates in connection with the audio UI-location indicator 102, 202 to output audio signals that provide an indication to the user of the user's location within the user interface of the mobile device 300. The touchscreen 312 generally operates to display the user interface to a user and functions as an input device for the user, and the touchscreen may be realized by any of a variety of touchscreen displays (e.g., LCD and OLED displays). And in general, the nonvolatile memory 320 functions to store (e.g., persistently store) data and executable code including code that is associated with the functional components depicted in FIGS. 1 and 2. In some embodiments for example, the nonvolatile memory 320 includes bootloader code, modem software, operating system code, file system code, and code to facilitate the implementation of the audio UI-location indicator 102, 202 and the UI navigation component 104 as well as other components well known to those of ordinary skill in the art that are not depicted nor described in connection with FIGS. 1 and 2 for simplicity. In addition, the audio file library 246 may reside in the non-volatile memory 320.

In many implementations, the nonvolatile memory 320 is realized by flash memory (e.g., NAND or ONENAND memory), but it is certainly contemplated that other memory types may be utilized as well. Although it may be possible to execute the code from the nonvolatile memory 320, the executable code in the nonvolatile memory 320 is typically loaded into RAM 324 and executed by one or more of the N processing components 326.

The N processing components 326 in connection with RAM 324 generally operate to execute the instructions stored in nonvolatile memory 320 to effectuate the functional components depicted in FIGS. 1 and 2. For example, when executed the UI navigation component 104 and the software portion of the audio UI-location indicator 102, 202 may reside in RAM 324 and may be executed by one or more of the N processing components 326. As one of ordinarily skill in the art will appreciate, the N processing components 326 may include a video processor, modem processor, DSP, graphics processing unit (GPU), and other processing components.

The transceiver component 328 includes N transceiver chains, which may be used for communicating with one or more networks. Each of the N transceiver chains may represent a transceiver associated with a particular communication scheme. For example, each transceiver may correspond to protocols that are specific to local area networks, cellular networks (e.g., a CDMA network, a GPRS network, a UMTS networks), and other types of communication networks.

The accelerometer 330 generally functions to provide one or more outputs indicative of an acceleration of the mobile communication device 300 in one, two, or three dimensions in space and may be used to sense an orientation of the mobile communication device 300. In some implementations it may be used to select and/or change the page of the user interface that is being viewed.

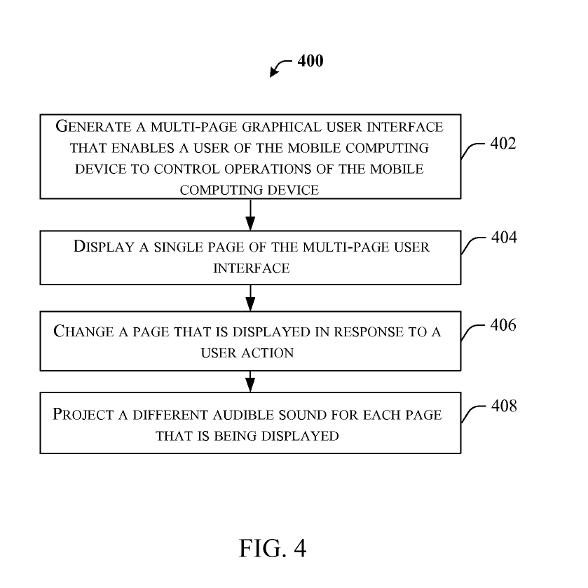

Referring next to FIG. 4, it is a flow chart depicting a method that may be traversed in connection with the embodiments described with reference to FIGS. 1-3. As shown, the method includes generating a multi-page graphical user interface that enables a user of a mobile device to control operations of the mobile device (Block 402). In connection with the embodiment depicted in FIG. 1 for example, the UI navigation component 104 may generate the multi-page graphical user interface. And as discussed above, each of the pages of the user interface may include icons associated with different functions (e.g., power control, backlight level, WiFi control, Bluetooth control, etc.) and apps (e.g., gaming apps, utilities, entertainment apps, etc.).

As depicted in FIG. 4, in this method only a current page of the multi-page user interface is displayed at a time (Block 404). As one of ordinary skill in the art will appreciate, the smaller the display size of the mobile communication device, the greater the number of pages may be necessary to display all of the icons or control buttons. But some user interfaces have a fixed number of pages and the number of icons that may be displayed in a page may vary. In any case, the user is unable to view all of the pages simultaneously; thus in many instances the user must scroll though one or more pages of the user interface to locate a desired icon or button. As a consequence, the page that is displayed is changed in response to a user action (Block 406). The user action may be a swipe gesture when the display 110 is realized as a touch screen, but it is contemplated that other user gestures may be used to trigger a change in the page of the user interface that is displayed.

As shown in FIG. 4, for each page that is being displayed, a different audible sound is generated and projected (Block 408). As discussed, in some embodiments the frequency or pitch of the sound changes for each page that is displayed. But as discussed above, many different types of sounds (e.g., default or custom sounds) may be associated with each page of the user interface so that the user of the mobile communication device 100, 300 may learn to associate a particular sound with a particular user interface page. In an embodiment, one or more sounds may be associated with a single page, or associated with a number of pages, or each page may be uniquely associated with its own sound.

While the foregoing disclosure discusses illustrative aspects and/or aspects, it should be noted that various changes and modifications could be made herein without departing from the scope of the described aspects and/or aspects as defined by the appended claims. Furthermore, although elements of the described aspects and/or aspects may be described or claimed in the singular, the plural is contemplated unless limitation to the singular is explicitly stated. Additionally, all or a portion of any aspect and/or aspect may be utilized with all or a portion of any other aspect and/or aspect, unless stated otherwise.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal In the alternative, the processor and the storage medium may reside as discrete components in a user terminal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A mobile communication device, comprising:
a display that presents a current page of a multi-page user interface;
a user interface navigation component that generates the multi-page user interface and changes the current page of the multi-page user interface in response to user actions;
an audio user interface location indicator that initiates an audio signal associated with the current page of the multi-page user interface; and
an audio transducer that projects an audible sound based upon the audio signal.

2. The mobile communication device of claim 1, wherein the display includes a touchscreen that generates signals indicative of locations of user-touch-events on a surface of the touchscreen, and the user interface navigation component changes the current page of the multi-page user interface in response to the user-touch-events.

3. The mobile communication device of claim 1, wherein the audio signal is one of a plurality of audio signals, each of the plurality of audio signals associated with a page of the multi-page user interface.

4. The mobile communication device of claim 1, including:
an audio file library that includes a collection of audio files; and
an audio-UI selection component that presents a listing of audio content that is available in the audio files and enables the user to select particular audio content from the listing, wherein the audio user interface location indicator initiates the audio signals using the particular audio content.

5. The mobile communication device of claim 4, including:
a custom audio user interface generation component that enables the user to create a custom arrangement of audio content that the audio user interface location indicator uses to initiate the audio signals.

6. A method for controlling a mobile communication device, the method comprising:
generating a multi-page user interface that enables a user of the mobile communication device to control operations of the mobile communication device;
displaying a current page of the multi-page user interface;
changing the current page of the multi-page user interface in response to a user action; and
projecting an audible sound for each page of the multi-page graphical user interface.

7. The method of claim 6 including:
displaying the current page on a touchscreen of the mobile communication device;
detecting a user-touch-event on the touchscreen; and
changing the current page in response to the user-touch-event.

8. The method of claim 6, including:
selecting the audible sound from a plurality of audible sounds, each of the plurality of audible sounds associated with a page of the multi-page user interface.

9. The method of claim 6, including:
providing a listing of audio content that is available on the mobile communication device;
detecting a user's selection of particular audio content from the listing; and
projecting, using the particular audio content selected by the user, an audible sound for each page.

10. The method of claim 9, including:
providing options for the user to create custom audio content; and
including the custom audio content in the listing of audio content.

11. A mobile communication device, comprising:
means for generating a multi-page user interface that enables a user of the mobile communication device to control operations of the mobile communication device;
means for displaying a current page of the multi-page user interface;
means for changing the current page of the multi-page user interface in response to a user action; and
means for projecting an audible sound for each page of the multi-page graphical user interface.

12. The mobile communication device of claim 11, including:
means for displaying the current page on a touchscreen of the mobile communication device;
means for detecting a user-touch-event on the touchscreen; and
means for changing the current page in response to the user-touch-event.

13. The mobile communication device of claim 11, including:
means for selecting the audible sound from a plurality of audible sounds, each of the plurality of audible sounds associated with a page of the multi-page user interface.

14. The mobile communication device of claim 11, including:
means for providing a listing of audio content that is available on the mobile communication device;
means for detecting a user's selection of particular audio content from the listing; and
means for projecting, using the particular audio content selected by the user, an audible sound for each page.

15. The mobile communication device of claim 14, including:
means for providing options for the user to create custom audio content; and; and
means for including the custom audio content in the listing of audio content.

16. A non-transitory, tangible computer readable storage medium, encoded with processor readable instructions to perform a method for controlling a mobile communication device, the method comprising:
generating a multi-page user interface that enables a user of the mobile communication device to control operations of the mobile communication device;
displaying a current page of the multi-page user interface;
changing the current page of the multi-page user interface in response to a user action; and
projecting an audible sound for each page of the multi-page graphical user interface.

17. The non-transitory, tangible computer readable storage medium of claim 16, the method including:
displaying the current page on a touchscreen of the mobile communication device;
detecting a user-touch-event on the touchscreen; and
changing the current page in response to the user-touch-event.

18. The non-transitory, tangible computer readable storage medium of claim 16, the method including:
selecting the audible sound from a plurality of audible sounds, each of the plurality of audible sounds associated with a page of the multi-page user interface.

19. The non-transitory, tangible computer readable storage medium of claim 16, the method including:
providing a listing of audio content that is available on the mobile communication device;
detecting a user's selection of particular audio content from the listing; and
projecting, using the particular audio content selected by the user, an audible sound for each page.

20. The non-transitory, tangible computer readable storage medium of claim 19, the method including:
providing options for the user to create custom audio content; and
including the custom audio content in the listing of audio content.
